(19) United States
(12) Patent Application Publication
(10) Pub. No.: US 2014/0254866 A1
(43) Pub. Date: Sep. 11, 2014

(54) PREDICTIVE ANALYSIS USING VEHICLE LICENSE PLATE RECOGNITION

(71) Applicant: Next Level Security Systems, Inc., Carlsbad, CA (US)

(72) Inventors: Peter A. Jankowski, Rancho Santa Fe, CA (US); Chen-Lan Yen, Carlsbad, CA (US); Rand D. Anderson, Cardiff, CA (US)

(73) Assignee: Next Level Security Systems, Inc., Carlbad, CA (US)

(21) Appl. No.: 13/790,389

(22) Filed: Mar. 8, 2013

(51) Int. Cl. G06K 9/00

(52) U.S. Cl. CPC G06K 9/00771
USPC 382/103

(57) ABSTRACT

A method and a system for predictive analysis using vehicle license plate recognition are described. The system has a gateway, a web server, and a client device. The gateway is coupled to security devices. The web server has a management application configured to communicate with the gateway. The client device communicates with the gateway identified by the web server. The gateway monitors data from security devices coupled to the gateway. A predictive behavioral model is generated using historical data from the monitoring data comprising identified characters in license plates of vehicles monitored by the security devices.

### TECHNICAL FIELD

This application relates generally to the field of computer technology, and in a specific example embodiment, to predictive analysis using vehicle license plate recognition.

### BACKGROUND

Vehicle license plate recognition systems typically make use of specialized cameras. For example, cameras may include infrared flashes or illumination to allow the camera to take a picture at any time of the day. However, these cameras are limited in their operation based on the amount of time it takes the infrared flash to reset or recharge. Furthermore, those cameras need to be positioned in a very specific location and angle in order for them to operate properly. For example, some infrared cameras have limited range and need to be positioned at about the same height of the license plate on a car. Another difficulty is that cameras with infrared illumination can only capture the license plate of a vehicle because only the license plate can reflect the infrared illumination.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, for exchanging data over a computer network.

FIG. 2A is a block diagram illustrating an example embodiment of a gateway.

FIG. 2B is a block diagram illustrating another example embodiment of a gateway.

FIG. 2C is a block diagram illustrating an example embodiment of a web-based monitoring application of the gateway of FIG. 2A.

FIG. 2D is a block diagram illustrating an example embodiment of a license plate module.

FIG. 2E is a block diagram illustrating an example of a display generated by a license plate display module.

FIG. 2F is a block diagram illustrating an example of scanning license plates of vehicles parked in a parking lot.

FIG. 3 is a block diagram illustrating an example embodiment of a web server.

FIG. 4 is a flow chart of one embodiment of an example method for monitoring and controlling devices attached to a gateway.

FIG. 5 is a flow chart of one embodiment of an example method for communicating with a gateway and a web server from a client device.

FIG. 6 is a flow chart of one embodiment of an example method for communicating with a gateway and a client device from a web server.

FIG. 7 is a flow chart of one embodiment of an example method for communicating with a web server and a client device from a gateway.

FIG. 8 is a flow chart of one embodiment of an example method for generating dynamic indicators corresponding to the license plate of a vehicle.

FIG. 9 is a flow chart of one embodiment of an example method for scanning license plates of vehicles in a parking lot.

FIG. 10 is a flow chart of one embodiment of an example of predictive analysis using vehicle license plate recognition.

FIG. 11 shows a diagrammatic representation of a machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, a method and a system for identifying a vehicle license plate is described. The system has a gateway, a web server, and a client device. The gateway also detects, identifies, and tracks a license plate of a vehicle using a non-infrared high sensitivity camera coupled to the gateway. The gateway is coupled to a security device. The web server has a management application configured to communicate with the gateway. The client device communicates with the gateway identified by the web server. The gateway aggregates monitoring data from the security device and from other security devices respectively coupled to other gateways correlated with the gateway. The client device receives the aggregated monitoring data, controls the security device coupled to the respective gateway from a web-based user interface at the client device. The gateway generates dynamic indicators corresponding to the license plate on a picture generated by the non-infrared high sensitivity camera.

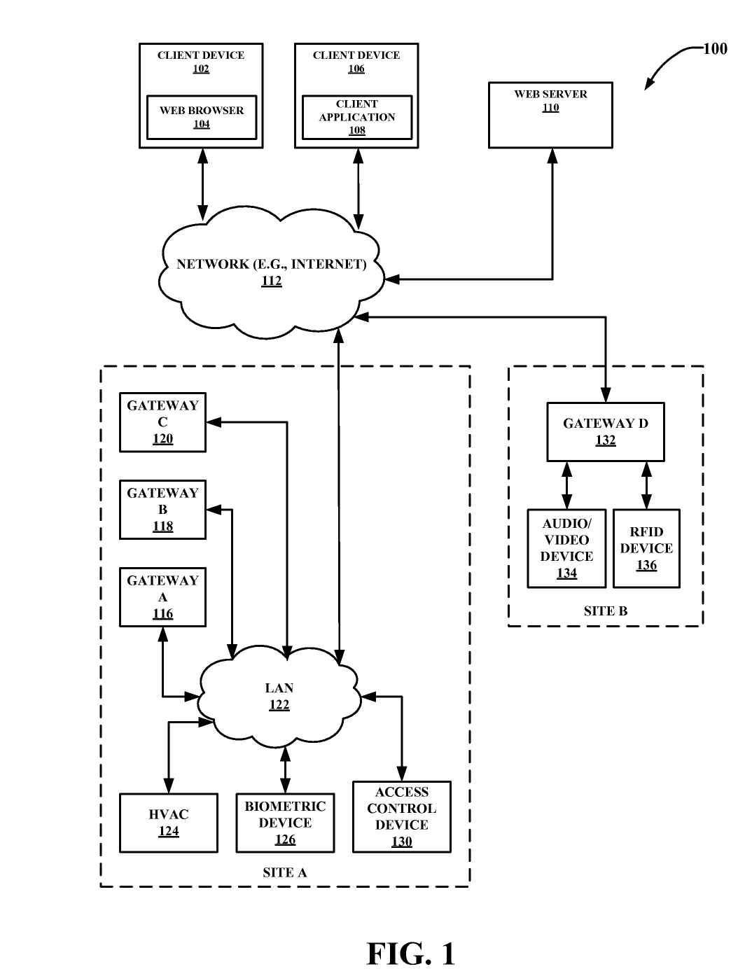

FIG. 1 is a network diagram depicting a network system 100, according to one embodiment, for exchanging data over a network 112 (e.g. TCP/IP network). For example, the network system 100 comprises client devices 102, 106, a web server 110, and gateways 116, 118, 120 at a location site A, and a gateway 132 at a location site B. For example, location site A may be a store in a city and location site B may be an office in another city. A location site may include, for example, one or more floors of an office building, a residential house, an embassy, a school building, a school campus, an area of a factory or retail space, and so forth. In another example, location sites may overlap each other.

For purposes of the present embodiment, the terms “sites” and “premises” refer to any location to be monitored, whether residential, commercial, public, or secured. Further, the term “a” is generally used in the present disclosure to mean one or more. Still further, the terms “coupled” and “operatively coupled” mean connected in such a way that data may be exchanged. It is understood that “coupled” and “operatively coupled” do not require a direct connection, a wired connection, or even a permanent connection. It is sufficient for purposes of the present embodiment that the connection(s) be established for the sole purpose of exchanging information.

The client devices 102, 106 are connected to the network 112. The client devices 102, 106 can include, but are not limited to, a desktop computer, a laptop computer, a mobile computing device, a mobile smart phone device, and so forth. A network interface means is provided to enable the client devices 102, 106 to send and receive data to and from the network 112. The client device 102 may include a web browser 104 that may be in communication with the web server 110 via the network 112. In another example, the client device 106 includes a programmatic client, such as a client application 108 configured to communicate with the web server 110 via the network 112. The web browser 104 or the client application 108 may be used to display some or all of the information and monitoring data provided by gateways 116, 118, 120, and 132.

The network 112 can include a local area network (LAN) where Gigabit Ethernet switches are used to switch data. In another example, the network 112 includes a wide area network, such as the Internet. In general, network 112 may be a public network or private network, a single network or a combination of several networks. In most embodiments, the computer network 120 may be, but is not required to be, an IP-based network. In some embodiments it may be desirable for all or a portion of the network 120 to include publicly available networks, such as the Internet, to avoid the need for installing, purchasing, or leasing additional infrastructure.

The web server 110 may also connect to the network 112 both to receive and transmit data. The web server 110 may also be referred to as a web-based host. The web server 110 is connected to the network 112 by a means of a network interface. The network interface can take the form of a network interface card (not shown) installed within the web server 110 to enable data sent and received to and from the network 112 by the web server 110.

In one embodiment, the web server 110 identifies one or more gateway(s) for the client devices 102, 106 to communicate with, so as to monitor and/or control the security devices connected to the corresponding gateway(s).

In another embodiment, the web server 110 may provide server-side functionality, via the network 112, to the client devices 102, 106. The client devices 102, 106 may enable users that utilize the network system 100 and more specifically, the web server 110, to view monitoring data (e.g. audio/video feed) from security devices connected to gateways 116, 118, 120, and 132 over the network 112. These transactions may include transmitting, receiving (communicating) and processing data to, from, and regarding monitoring data and users of the network system 100. The data may include, but is not limited to audio, video, picture, metadata, camera configuration data, client device configuration data, and network data monitoring data. The web server 110 can provide other functions including storing monitoring data to an internal or external disk storage device (not shown), playing back recorded monitoring data. In one embodiment, the web server 110 may perform analytics computation on the data from the gateways 116, 118, 120, and 132.

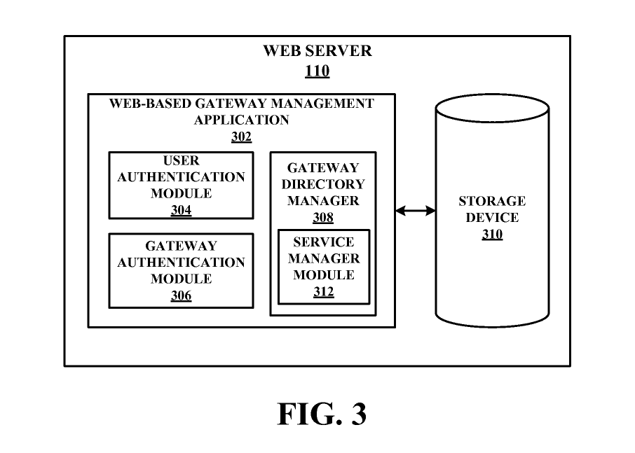

In one embodiment, the web server 110 may include a directory of gateways and the location of security devices connected to each gateway (e.g., camera a is located in room b at location c associated with gateway d, gateway e is associated with building f, etc. . . . ). The web server 110 is described in more detail below with respect to FIG. 3. As such, the web server 110 may correlate the gateway 116 at site A to the gateway 132 at site B. In one embodiment, the correlation may be generated pursuant to pre-defined settings or configuration based on user profile, organization topology, hierarchy, bandwidth and other factors. For example, a user at client device 102 may be a manager responsible for stores located on the West coast. If both sites A and B are on the West coast, the web server correlates gateway 116 to gateway 132. As such, based on the user profile and the organization topology, the user can access only gateway 116 to obtain monitoring data from sites A and B. In other words, the user does not have to communicate directly with several gateways to monitor all security devices attached to the corresponding gateways. In another embodiment, the web server 110 may correlate gateway 116 with other gateways. In yet another embodiment, the other gateways may be correlated with other gateways. For example, information from other gateways correlated with gateway 132 which is correlated with gateway 116 may be communicated with the user at the client device 102 or 106.

Generally, gateways 116, 118, 120, and 132 include a processor-based device that operates to monitor conditions at a target site or premise, to analyze monitoring data, to detect alarm conditions at the target site or premise, to capture information relating to such alarm conditions, and to send such monitoring information to client devices 102, 106 and/or the web server 110.

Gateways 116, 118, and 120 are located at the same site A. In one embodiment, gateways 116, 118, and 120 are capable of balancing their respective load. Furthermore, gateways 116, 118, and 120 may provide a redundant backup of each other. Gateways 116, 118, and 120 are connected to a local area network LAN 122. In another embodiment, gateways 116, 118, and 120 communicate with one another via a peer-to-peer network.

Security devices (e.g. monitoring devices and controlling devices) 124, 126, and 130 are connected to the gateways 116, 118, and 120 via LAN 122. Monitoring devices include, for example, sensors. The gateways 116, 118, and 120 are not limited to connect to any specific type or model of sensors or monitoring devices. Any sensor may be used, depending on the desired type and level of protection. Examples include, without limitation, microphones, cameras, magnetic contact switches, audio sensors, infrared sensors, motion detectors, fire alarms, and carbon monoxide sensors. For illustration purposes, location site A in FIG. 1 includes a biometric device 126 (e.g. fingerprint reader), and an access control device 130 (e.g. door/gate access sensor).

In addition, controlling devices may include devices that can be controlled such as a HVAC system 124 (e.g. heater/air conditioning system including thermometer, smoke sensor, thermostat), a gate/door lock, and a camera positioning system (e.g. tilt, pan).

The HVAC system 124, the biometric devices 126, and the access control device 130 are located at site A and are connected to the gateway 116 via LAN 122.

The gateway 132 is located at another location site B away from location site A (e.g. different physical locations). An audio/video device 134 (e.g. camera, microphone) and an RFID device 136 (e.g. card reader) are directly connected to gateway 132. The gateway 132 communicates with the network 112.

In another embodiment, gateways 116, 118, and 120 from site A communicate with the gateway 132 from site B. As such, client devices 102, 106 can monitor data from audio/video device 134 and RFID device 136 connected to the gateway 132 by communicating only with the gateway 116. Similarly, client devices 102, 106 can monitor data from the HVAC 124, the biometric device 126, and the access control device 130 connected to gateway 116 by communicating only with the gateway 132.

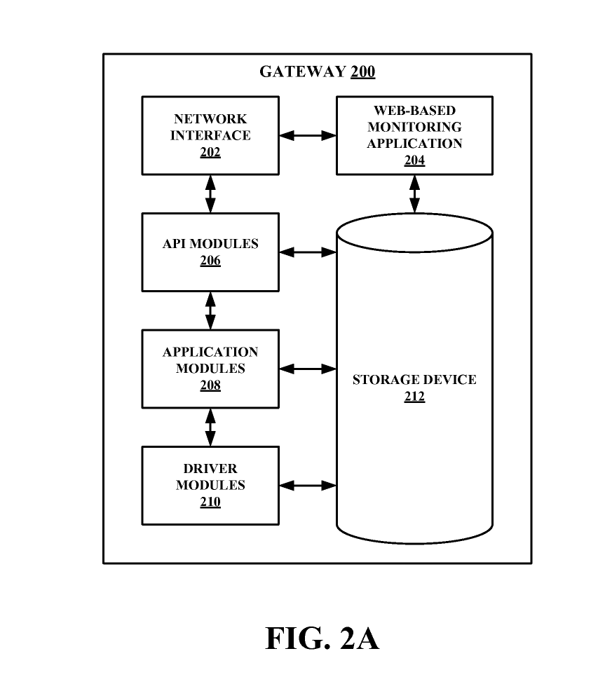

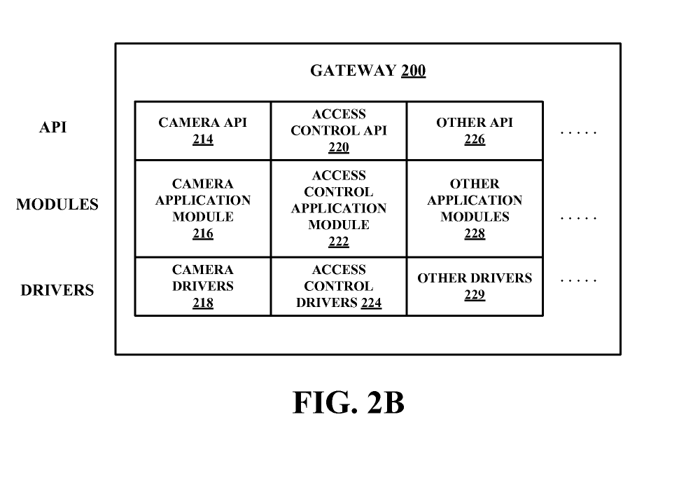

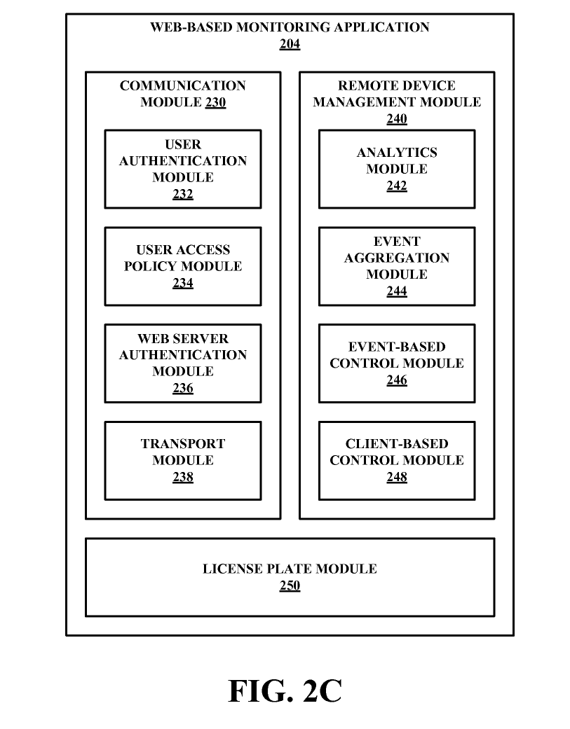

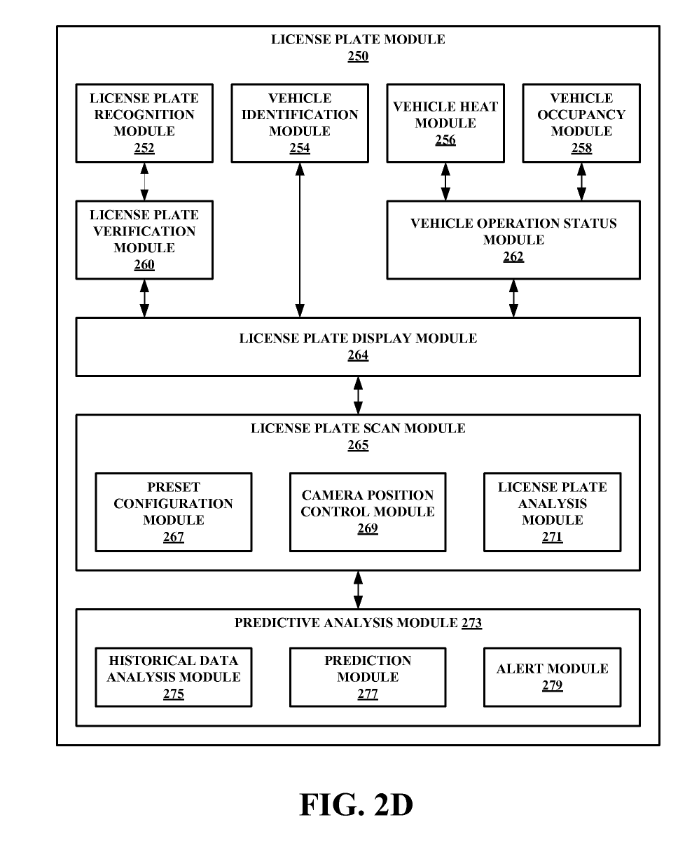

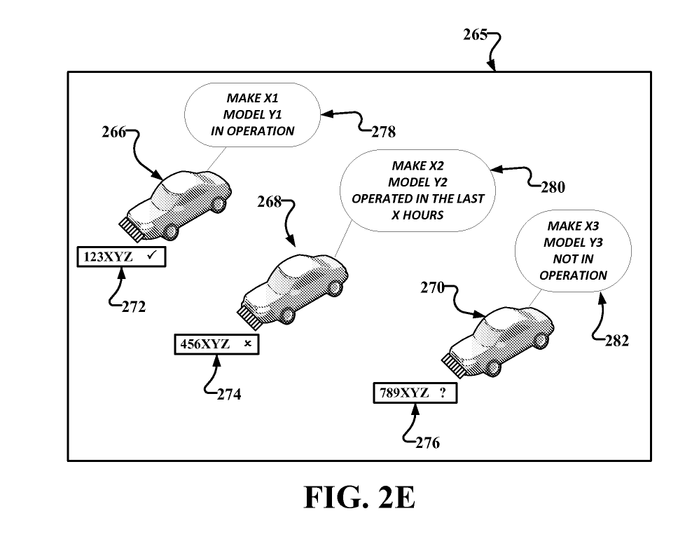

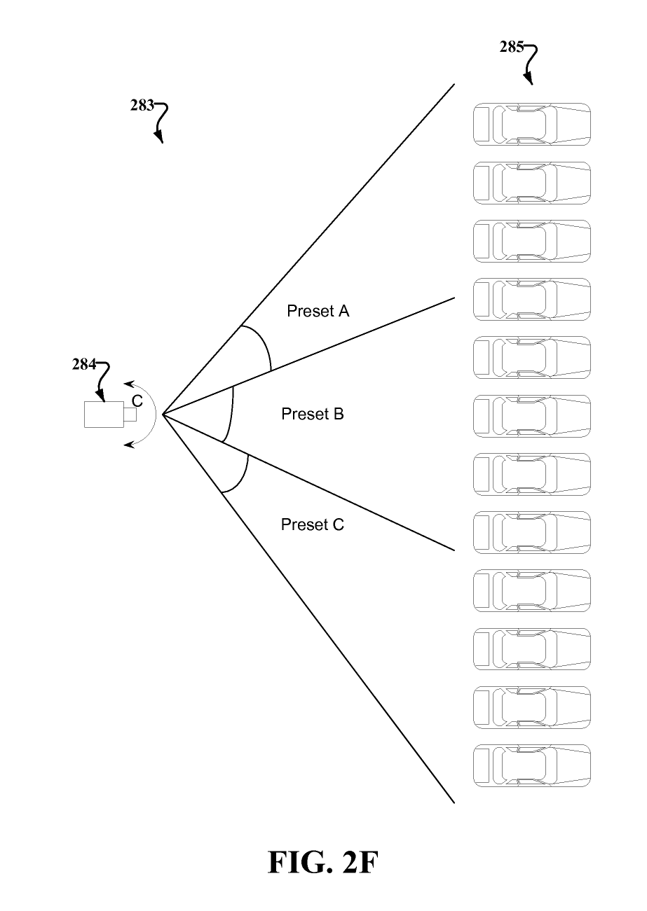

FIG. 2A is a block diagram illustrating an example embodiment of a gateway 200. The gateway 200 includes a network interface 202, API modules 206, application modules 208, driver modules 210, a web-based monitoring application 204, and a storage device 212. The network interface 202 enables the gateway 200 to communicate with the network 112. The application programming interface (API) enable the gateway 200 to interface the gateway 200 with the client devices 102, 106, the web server 110, and other third party devices (not shown). The application modules 208 enable the gateway 200 to monitor or control the corresponding monitoring or controlling devices connected to the gateway 200. In addition, the application modules 208 enable the gateway 200 to provide add-on expandable services discussed further below. The driver modules 210 include device drivers to enable interaction of the application modules 208 with the hardware of the corresponding monitoring or controlling devices. The web-based monitoring application 204 enables the gateway 200 to communicate monitoring and controlling data with the client device 102,106. The web-based monitoring application 204 is discussed in more detail with respect to FIG. 2C. The storage device 212 may be used to store monitoring data from the monitoring devices connected to the gateway 200, APIs from API modules 206, software application from application modules 208, device drivers from driver modules 210, and a configuration of the gateway 200. For example, the configuration of the gateway 200 may include a topology or hierarchy of a user level, organization level, and partner level. The configuration of the gateway 200 may include specifically an enterprise configuration of the gateway 200 (based on the topology/hierarchy previously described). In one embodiment, the configuration of the gateway 200 may be replicated to other gateways that are correlated by the web server 110 based on the topology/hierarchy. For example, some gateways 200 can have access control to a limited number of security devices. In another embodiment, each gateway 200 may be custom configured. In another embodiment, the gateway 200 is configured to aggregate data from multiple gateways (that may be correlated by the web server 110 based on the topology) and present the aggregated data to the client device 102, 106.

FIG. 2B is a block diagram illustrating another example embodiment of the gateway 200. For example, the gateway 200 includes a camera API 214, a camera application module 216, and camera drivers 218. The camera API 214 provides an interface to the web browser 104 or the client application 108 of the client device 102, 106 to receive and send data from a camera connected to the gateway 200. The camera application module 216 enables the client device 102,106 to receive data (e.g. audio and video) from the camera via the camera API 214. In another embodiment, the camera application module 216 enables the client device 102,106 to send commands (e.g. focus, tilt, pan, zoom) or data to the camera via the camera API 214. The camera drivers 218 include one or more drivers for different brands or manufacturers of camera.

In another example, the gateway 200 may also include an access control API 220, an access control application module 222, and access control drivers 224. The access control API 220 provides an interface to the web browser 104 or the client application 108 of the client device 102,106 to receive and send data from an access control device 130 (e.g. a door access at a monitored site) connected to the gateway 200. The access control application module 222 enables the client device 102,106 to receive data (e.g. time and ID log of the door access at the monitored site) from the access control device 130 via the access control API 220. In another embodiment, the access control application module 222 enables the client device 102,106 to send commands (e.g. open, close, lock door) or data to the access control device 130 via the access control API 220. The access control drivers 224 include one or more drivers for different brands or manufacturers of access control devices 130.

One benefit of one of the embodiments of the gateway 200 is the ability to easily connect additional devices or third party devices. This is illustrated with respect to other API 226, other application module 228, and other drivers 229. As such, the gateway 200 is not limited to any particular manufacturer of devices or brand of devices. The gateway 200 allows for easy expansion and plug-in features using additional APIs, corresponding modules, and corresponding device drivers.

FIG. 2C is a block diagram illustrating an example embodiment of the web-based monitoring application 204 of the gateway 200. The web-based monitoring application 204 enables client devices 102, 106 to remotely monitor and control monitoring and controlling devices connected to the gateway 200 via the web browser 104 or the client application 108 at the client devices 102, 106. In one embodiment, the web-based monitoring application 204 includes a communication module 230, a remote devices management module 240, and a license plate module 250. The communication module 230 enables communication between the gateway 200 and the client devices 102, 106. The remote devices management module 240 enables the client devices 102, 106 to monitor and control devices connected to the gateway 200.

In one embodiment, the communication module 230 includes a user authentication module 232, a user access policy module 234, a web server authentication module 236, and a transport module 238.

The user authentication module 232 authenticates a user at the client device 102,106 based on a user profile of the user. An example of user authentication may include verifying the username and password provided by the client device 102,106 with a predefined user profile. The predefined user profile may be stored in the storage device 212 or at the web server 110.

The user access policy module 234 limits or grants the user at the client device 102,106 access to the monitoring and/or controlling devices connected to the gateway 200. For example, a user with limited privilege may have access to the monitoring data to a particular site (e.g. first floor only) or a specific monitoring device (e.g. HVAC only). On the other hand, a user with executive privilege may not only be able to view monitoring data and control security devices from more sites.

The web server authentication module 236 authenticates a communication between the gateway 200 and the web server 110. For example, the gateway 200 transmits a unique token to the web server 110 for authentication prior to establishing the secured communication. Those of ordinary skills in the art will recognize that other means of authentication between the gateway 200 and the web server 110 may be used.

The transport module 238 enables peer-to-peer communication between gateways. As such, a client device 102,106 communicating with one gateway at a first location is also able to communicate with another gateway at a second location.

In one embodiment, the remote device management module 240 of the web-based monitoring application 204 includes an analytics module 242, an event aggregation module 244, an event-based control module 246, and a client-based control module 248.

The analytics module 242 analyzes audio/video, and other detected changes from the monitoring devices and generates events based on the analysis. For example, the analytics module 242 is capable of determining how many people have entered or left an activity zone (e.g. a room, a hallway) in a video feed, the direction of the movement of individuals in a video feed, the temperature of individuals in a video feed, facial recognition of individual in a video feed, and so forth. Events are generated based on the analysis and predefined user-configured settings. A user at the client device 102,106 is able to configure the conditions for generating an event from the web browser 104 of the client device 102 or the client application 108 of the client device 106.

The event aggregation module 244 aggregates events generated from the analytics module 242. For example, events generated based on the analysis and predefined/user-configured settings are aggregated in a log stored in a storage device 212 attached to the gateway 200, in a storage device 212 attached to another gateway, in a storage device 212 attached to the web server 110, or in a storage device 212 connected to the client device 102,106.

The event-based control module 246 communicates a command to at least one controlling device connected to the corresponding gateway 200 based on an event identified in event aggregation module 244 based on an event configuration. For example, an event comprises a temperature of a room reaching a predefined maximum temperature. The event-based control module 246 may communicate to the HVAC system 124 to turn on the air conditioning system for the room if such event occurs.

The client-based control module 248 communicates a command to one or more controlling devices of the corresponding gateway 200 based on a command initiated and communicated from the client device 102,106. For example, a user at the client device 102,106 may initiate a command to pan a camera connected to the gateway 200. Such command would be communicated to the camera via the client-based control module 248.

The license plate module 250 detects, identifies, and tracks a license plate of a vehicle using a non-infrared high sensitivity camera coupled to the gateway 200. The license plate module 250 can also generate dynamic indicators corresponding to the license plate on a picture generated by the non-infrared high sensitivity camera. In other words, the dynamic indicators may be updated based on the content or characters of the license plate.

FIG. 2D is a block diagram illustrating an example embodiment of the license plate module 250 of a gateway 200. The license plate module 250 may include a license plate recognition module 252, a vehicle identification module 254, a vehicle heat module 256, a vehicle occupancy module 258, a license plate verification module 260, a vehicle operation status module 262, a license plate display module 264, a license plate scan module 265, and a predictive analysis module 273.

The license plate recognition module 252 detects and identifies characters in the license plate in the picture from a non-infrared camera instead of a conventional infrared illumination camera as used in other license plate recognition systems. In particular, the license plate recognition module 252 may operate with any conventional non-infrared illumination camera. High sensitivity cameras may also be used to further help the license plate recognition process.

In one embodiment, the license plate recognition module 252 includes an algorithm for recognizing characters in license plates from images generated by a convention non-infrared illumination camera. The following illustrates one embodiment of a pseudo code of the license plate recognition algorithm:

set the detection zone from the target scene

read OCR Table from DB files

each character in OCR Table contain 82 numbers indicating their feature sets

read new frame
convert image into gray scale
break down the image to small bricks based on the image size
loop through all bricks in its scale level:
   local normalization for every brick
   remove isolated bricks
   associate connected brick regions
   determine the maximum/minimum brick region by probabilities
sort extracted brick regions by its density
loop through all brick regions, determine possible plates
   normalize brick regions
   filter unlike plate region by checking minimum/maximum pixel size
loop through plates, determine overlap
segment characters in plate
   apply different threshold for finding flood fill characters within expected size bound
   make small vertical cuts to help disconnect letters from bottom border
   check if segment has proper proportions
   filter out-bound characters
try to match all characters in the same vertical center lines
   filter overlapped X line characters, filter gap
   finding the central threshold for all characters
   extracting feature sets, try to match OCR tables
   generate confidence list for each characters
   try to fill segment gap
   try to extend out one character
   try to slice off bottom from plate frames
determine the rotation of the plate
determine the fade out direction of the plate
calculate point to pivot and the shear pivot
re-sample plate to counteract tilt
merge existing plates from the historical result
   create new possible character slot
   fill in the segment gap
   replacing low confidence characters
   filter the invalid string size (4-8)
   determine the existence of this plate

event generation
new plate
license plate string update
plate gone

The license plate verification module 260 accesses data corresponding to the license plate of the vehicle based on the license plate recognition module 252. In one embodiment, the license plate verification module 260 compares the characters obtained from the license plate recognition module 252 with a database to determine validity or a status associated with the license plate. For example, the license plate verification module 260 may access the database of a department of motor vehicles to determine the registration status of the vehicle, unpaid parking tickets or fines, owner registration name and address, among other things. In another example, the license plate verification module 260 may access the database associated with a parking lot to determine whether the vehicle is permitted to park in a parking spot of the parking lot. The license plate verification module 260 may communicate the status associated with the license plate to the license plate display module 264 for display.

The vehicle identification module 254 identifies a make and model of the vehicle in the picture from the non-infrared high sensitivity camera. In one embodiment, the vehicle identification module 254 accesses a database of reference images of vehicles to determine the make and model of the vehicle. The vehicle identification module 254 may look for key features uniquely attributable to each make and model.

The license plate display module 264 may generates a first set of indicators associated with the accessed data corresponding to the license plate and a second set of indicators associated with the make and model of the vehicle in the picture, the first and second set of indicators adjacent to the vehicle in a display.

The vehicle heat module 256 computes how long a vehicle has parked based on the amount of heat generated by the vehicle and an ambient temperature around the vehicle. The ambient temperature of the environment around the vehicle may be used as a reference to offset values from the temperature of the vehicle.

The vehicle occupancy module 258 detects and identifies a presence of one or more individuals in the vehicle. For example, images from the camera may show the number of passengers in the vehicle.

The vehicle operation status module 262 generates a third set of indicators corresponding to how long the vehicle has parked and the presence of one or more individuals in the vehicle. The third set of indicators is also generated to be shown in the display.

In another embodiment, the license plate display module 264 may also dynamically adjust the first and second set of indicators in the display based on a movement of the vehicle in the display. In other words, the indicators follow the movement of the vehicle. For example, indicators corresponding to the license plate of every vehicle in the frame may be displayed on each frame. As such, the identification and tracking of the license plates may be performed for every frame (or every n number of frames) outputted by the camera. Thus, the identification and tracking of the license plate does not depend on how often the infrared flash illumination can be reset or triggered. For example, infrared illumination cameras can only capture a picture every few seconds. As such, license plate recognition can only be performed accordingly on a frame generated every few seconds. In contrast, the license plate display module 264 of the present application allows for real time tracking of the license plate from a video camera and is not limited by how often the infrared illumination flash can be generated.

Furthermore, the license plate display module 264 may generate indicators on top of every frame from a video feed from a camera. In contrast, typical infrared illumination cameras can only capture snapshot pictures and thus cannot generate a video feed or live stream because of limitations from waiting for the infrared flash to be reset.

In one embodiment, the license plate scan module 265 includes a preset configuration module 267, a camera position control module 269, and a license plate analysis module 271.

The preset configuration module 267 generates a plurality of preset camera positions for the non-infrared camera to cover the location. Each preset camera position may correspond to a particular angle or setting of a pan, tilt, zoom camera. For example, the non-infrared camera may rotate through several positions in order to cover the entire location.

The camera position control module 269 directs the camera to move according to the plurality of preset camera positions.

The license plate analysis module 271 identifies the license plates at each preset camera position and compares the characters of each license plate at each preset camera position with a database to correlate the license plates with the plurality of preset camera positions.

In one embodiment, the predictive analysis module 273 includes a historical data analysis module 275, a prediction module 277, and an alert module 279.

The historical data analysis module 275 accesses the historical data collected with the license plate recognition module 252. For example, the license plate module 250 may record specific locations (e.g., parking stall, parking structure, parking lot) where a vehicle has parked or has been identified. For example, the historical data analysis module 275 may log the number of times, dates, and corresponding locations where a particular vehicle has parked or driven by. For example, the historical data may include the dates and time where a particular vehicle has crossed an intersection, or has left or entered a driveway.

In another embodiment, the historical data analysis module 275 collects data from other security devices to identify and log a tracking of a person associated with a license plate using facial recognition. For example, the person may be associated with two license plates because that person has been identified driving both cars on separate occasions.

The prediction module 277 generates a prediction behavioral model using statistical computation on the historical data. The prediction module 277 mines the historical data using conventional statistical computation to determine patterns. For example, the prediction module 277 may determine that a vehicle enters a structure (e.g., building, tunnel, parking lot) and exit the structure after x minutes representing the mean time duration within a period of time (e.g., last 30 days). In another example, the prediction module 277 computes that it take on average about x minutes for a particular individual to park his vehicle into a parking structure and use his security badge to access a building. The prediction module 277 analyzes the time log associated with the vehicle of the individual entering the parking structure and the time log of associated with the individual accessing the building.

The alert module 279 compares current data generated from a current picture from the non-infrared camera with the prediction behavioral model, and generates an alert based on the comparison. In one embodiment, if current data from the security devices deviate from the prediction behavioral model, an alert is generated.

For example, using the previous example, if 40 minutes have elapsed since a vehicle has entered a parking structure, and it would normally take 6 minutes for the individual associated with the vehicle to access a secure entry of a building, the alert module 279 may generate an alert to a mobile device of the individual and/or to a security staff.

FIG. 2E is a block diagram illustrating an example of a display 265 generated by the license plate display module 264. The license plate recognition module 252 determines that characters on each corresponding license plate from vehicles 266, 268, and 270. The characters of the license plates are shown in the corresponding display 272, 274, and 276. The license plate display module 264 may also generate an indicator in the displays 272, 274 and 276 based on a corresponding status. For example, a checkmark may be shown in the display 272 if the registration of the vehicle 266 is valid. In another example, a cross may be shown in the display 274 if the registration of the vehicle 268 has expired. The cross may also indicate the vehicle 268 has unpaid traffic or parking tickets, or has parked in someone else's assigned parking spot. In another example, a question mark may be shown in the display 276 if characters from the license plate are not recognized, or if the license plate verification module 260 cannot verify a status associated with the vehicle 270.

Indicators 278 may be displayed next to the vehicle 266 to provide information from the vehicle identification module 254 and from the vehicle operation status module 262. For example, indicators 278 may include the make and model of the vehicle 266 and an indicator that the vehicle is in operation (e.g., engine is running).

Indicators 280 may be displayed next to the vehicle 268 to provide information from the vehicle identification module 254 and from the vehicle operation status module 262. For example, indicators 280 may include the make and model of the vehicle 268 and an estimate as to how long ago the vehicle 268 has operated. In other words, indicators 280 may show the number of hours since the engine of the car has been turned off.

Indicators 282 may be displayed next to the vehicle 270 to provide information from the vehicle identification module 254 and from the vehicle operation status module 262. For example, indicators 282 may include the make and model of the vehicle 270 and an indicator that the vehicle is not in operation (e.g., engine is off).

As illustrated in FIG. 2E, a non-infrared camera may be used to identify and recognize characters on license plates of several vehicles at the same time using the same non-infrared camera. In contrast, infrared illuminated cameras can only capture one vehicle at a time and three different infrared illuminated cameras would be needed to capture the license plates of the three vehicles 266, 268, and 270 in FIG. 2E.

FIG. 2F is a block diagram illustrating an example of scanning license plates of vehicles 285 parked in a parking lot 283. A pan tilt zoom camera 284 may be positioned in the parking lot 283 such that it can scan as many parked cars as possible. For example, the pan tilt zoom camera 284 may include configuration presets A, B, and C where each preset will call for a portion of the parking lot 283. As such, when the pan tilt zoom camera 284 is at configuration preset A and directed to the corresponding vehicles 285 in the location covered by configuration preset A, the license plate module 250 as illustrated in FIG. 2D may detect and simultaneously identify several license plates of the corresponding vehicles 285 in configuration preset A.

To cover the entire location, the pan tilt zoom camera 284 may cycle through configuration presets A, B, and C. In one embodiment, the license plate analysis module 271 may correlate the license plate of a parked vehicle with a corresponding configuration preset to determine the location of the parked vehicle in reference to the parking lot 283.

FIG. 3 is a block diagram illustrating an example embodiment of a web server 110 also referred to as a web-based host. The web server 110 comprises a web-based gateway management application 302 and a storage device 310. The web-based gateway management application 302 identifies a gateway 200 associated with a user at the client device 102, 106, authenticates with the user at the client device 102, 106, and authenticates with the identified gateway 200.

In one embodiment, the web-based gateway management application 302 includes a gateway directory manager 308, a user authentication module 304, and a gateway authentication module 306. The gateway directory manager 308 identifies a gateway 200 associated with a user profile. For example, a user may only be able to access a particular gateway 200 or a particular set of devices connected to a gateway 200. As such, a west coast manager of an organization may be able to access monitored sites only from west coast stores of the organization. In contrast, a user with higher privileges may be able to access more gateways and devices. As such, the CEO of an organization with stores throughout the U.S. may be able to view monitoring data from all the stores in the United States. Law enforcement officials may be authenticated so that they can monitor, in a live manner, video and audio feeds from a parking lot or entrances and exits to a parking structure.

In another embodiment, the gateway directory manager 308 includes a service manager module 312 to enable add-on services to the user at the client device 102,106. For example, the add-on services include, but are not limited to, remote storage, remote audio, two-way audio, dynamic backup, or reporting based on the user profile.

The user authentication module 304 authenticates the web server 110 with the user at the client device 102,106 based on the user profile. For example, the web server 110 verifies the username and password of the user at the client device 102,106.

The gateway authentication module 306 authenticates the identified gateway 200. For example, the web server 110 receives a unique token from the identified gateway 200 to authenticate the identified gateway 200 prior to establishing secured communication between the web server 110 and the gateway 200.

The storage device 310 may be used to store user profiles, tokens from gateways 200, a directory of gateways with corresponding devices, services from the gateways 200, a directory of gateways associated with a user profile, and a directory of connected security devices associated with a user profile.

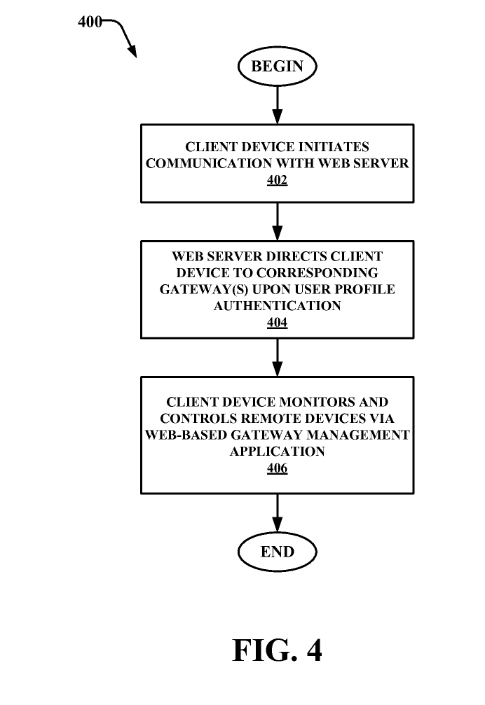

FIG. 4 is a flow chart of one embodiment of an example method for monitoring and controlling devices attached to a gateway 200. At 402, a user at a client device 102, 106 initiates communication with a web server 110 to access monitoring data from the devices connected to a gateway 200. At 404, the web server 110 directs the client device 102,106 to the corresponding gateway 200 based on the user profile of the user at the client device 102, 106. At 406, the client device is able to monitor and control from a central interface monitoring and controlling device connected to the identified gateway(s). In one embodiment, the client device 102, 106 receives an aggregated view of all the security devices from several correlated gateways by communicating with only one gateway.

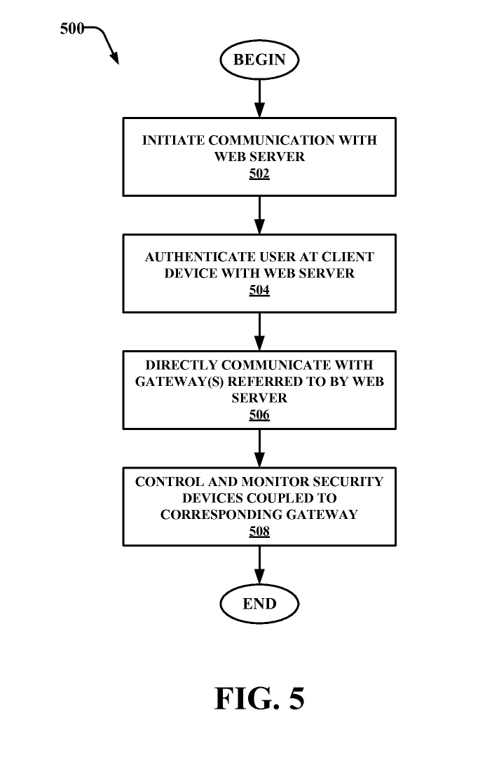

FIG. 5 is a flow chart of one embodiment of an example method for communicating with a gateway 200 and a web server 110 from a client device 102, 106. At 502, a client device 102, 106 initiates a communication with a web server 110. At 504, the client device 102, 106 authenticates the user with the web server 110. At 506, the client device 102, 106 directly communicates with the gateway(s) 200 referred and identified by the web server 110. At 508, the client device 102,106 is able to control and monitor devices connected to the corresponding gateway 200.

In another embodiment, the client device 102, 106 can control and monitor devices connected to other correlated gateways 200.

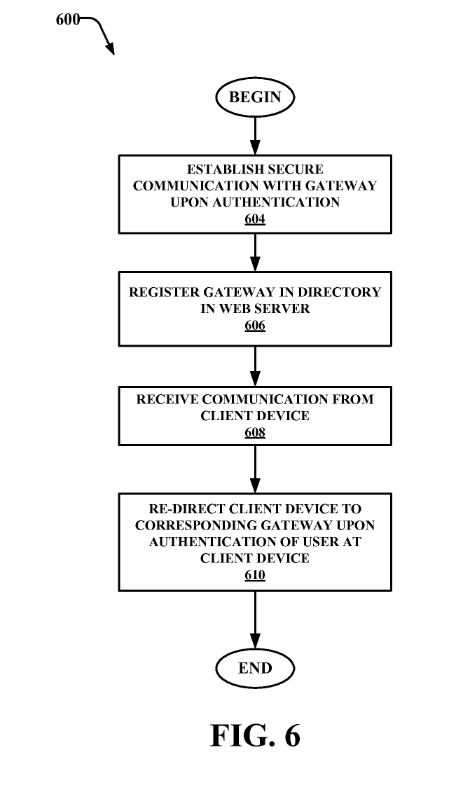

FIG. 6 is a flow chart of one embodiment of an example method for communicating with a gateway 200 and a client device 102, 106 from a web server 110. At 604, the web server 110 establishes a secure communication with a gateway 200 upon authentication of the gateway 200. At 606, the web server 110 registers the gateway 200 in a directory in the web server 110. At 608, the web server 110 receives a communication from the client device 102, 106 to access monitoring data. At 610, the web server 110 re-directs the client device 102,106 to the corresponding gateway 200 upon authentication of the user at the client device 102, 106. As such, the client device 102, 106 communicates directly with the identified gateway 200 thereby saving bandwidth resources from the web server 110.

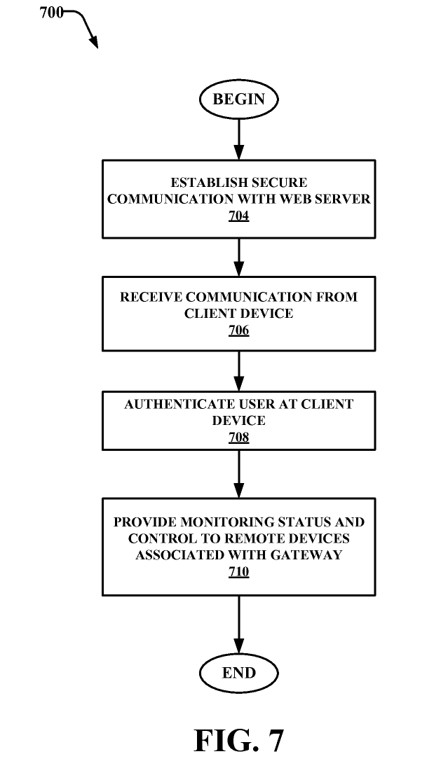

FIG. 7 is a flow chart of one embodiment of an example method 700 for communicating with a web server 110 and a client device 102, 106 from a gateway 200. At 704, the gateway 200 establishes a secure communication with the web server 110. At 706, the gateway 200 identified by a web server 110 receives a communication from a client device 102, 106. At 708, the gateway 200 authenticates the user at the client device 102, 106. At 710, the gateway 200 provides monitoring status and control to devices connected to the gateway 200. In another embodiment, the gateway 200 is correlated to other gateways by the web server 110. In other words, the web server 110 may introduce the gateway 200 to establish a direct secure communication with other gateways.

In another embodiment, the gateway 200 is interfaced with the client device 102, 106 with an application programming interface (API). The corresponding monitoring or controlling device coupled to the gateway 200 is monitored and controlled with an application module 208. Interaction of the application module 208 the corresponding monitoring or controlling device is enabled with a device driver.

In another embodiment, communication with the web server 110 and the client device 102, 106 is enabled with a communication module of the gateway 200. The client device 102, 106 is enabled to monitor or control the plurality of monitoring or controlling devices coupled to the gateway 200 with a remote devices management module 240 of the gateway 200.

In one embodiment, enabling communication with the web server 110 and the client device 102, 106 comprises authenticating a user at the client device 102, 106 based on a user profile of the user with a user authentication module 232. The user at the client device 102, 106 is limited or granted access to the monitoring and controlling devices with a user access policy module 234. A communication between the gateway 200 and the web server 110 is authenticated with a web server authentication module 236. The peer-to-peer communication between gateways is enabled with a transport module 238.

In one embodiment, enabling the client device 102, 106 to monitor or control the monitoring or controlling devices connected to the gateway 200 comprises analyzing audio and video from the monitoring devices and to generate events based on the analysis with an analytics module 242. The events generated from the analytics module 242 are aggregated with an event aggregation module 244. A command is communicated to at least one controlling device of the corresponding gateway 200 based on an event identified in the aggregated events based on an event configuration with an event-based control module 246. A command is communicated to at least one controlling device of the corresponding gateway 200 based on a command communicated from the client device 102, 106 with a client-based control module 248.

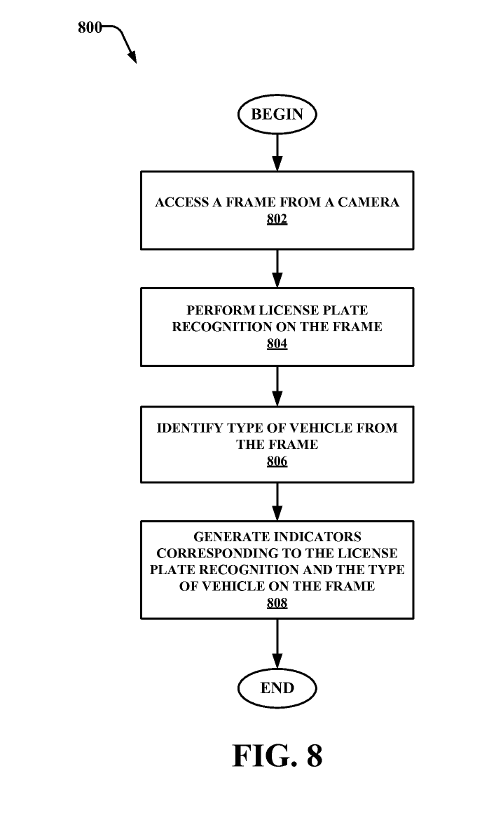

FIG. 8 is a flow chart of one embodiment of an example method 800 for identifying a vehicle license plate. At operation 802, the gateway 200 accesses a frame, an image, or a picture from a non-infrared camera (and optionally from a heat sensitive camera). At operation 804, the gateway 200 performs license plate recognition on the frame. At operation 806, the gateway 200 identifies the type of vehicle from the frame. At operation 808, the gateway 200 generates indicators corresponding to the license plate recognition and the type of vehicle on the frame. For example, the gateway 200 may generate a visualization in the form of a heads up display to show information corresponding to the license plate of the vehicle. In one embodiment, the indicators may dynamically follow the vehicle in the display from the camera. For example, indicators corresponding to the license plate of every vehicle in the frame may be displayed for each frame. As such, the identification and tracking of the license plates may be performed for every frame (or every n number of frames) outputted by the camera. Thus, the identification and tracking of the license plate does not depend on how often the infrared flash illumination can be reset or triggered. For example, infrared illumination cameras can only capture a picture every few seconds. As such, license plate recognition can only perform every few seconds.

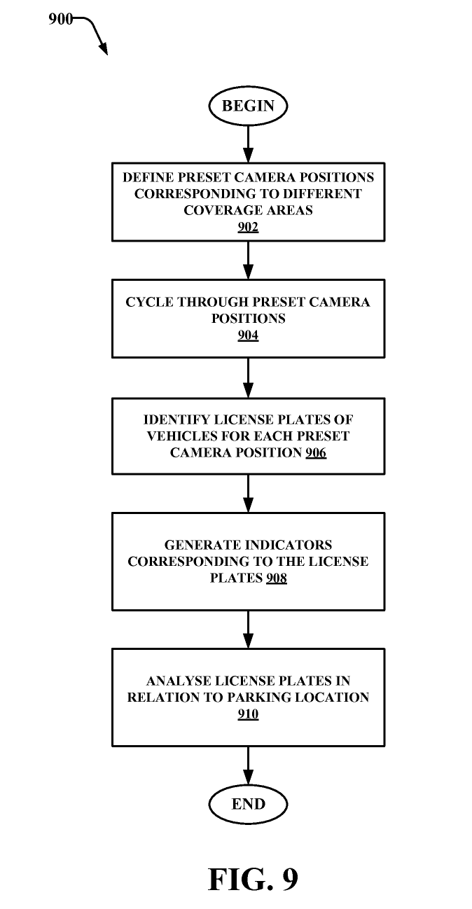

FIG. 9 is a flow chart of one embodiment of an example method 900 for scanning license plates of vehicles in a parking lot. At operation 902, preset camera positions are defined corresponding to different coverage areas. At operation 904 the camera's position move according to the different preset camera positions. At operation 906, license plates of vehicles for each preset camera position are identified. At operation 908, indicators corresponding to the license plates are generated for each preset camera position. At operation 910, license plates of the vehicles are analyzed in relation to their parking location.

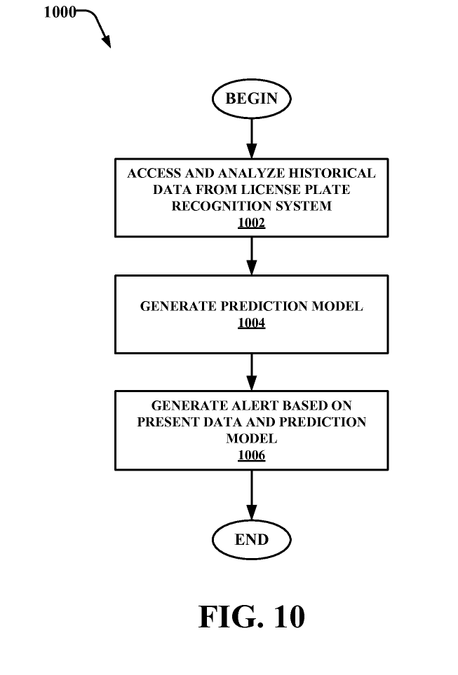

FIG. 10 is a flow chart of one embodiment of an example of predictive analysis 1000 using vehicle license plate recognition. At operation 1002, historical data collected from the security devices is collected, accessed, and analyzed. At operation 1004, a prediction behavioral model is generating using statistical computation on the historical data. Present or current data generated from the security devices are compared with the prediction behavioral model. At operation 1006, an alert may be generated based on the comparison.

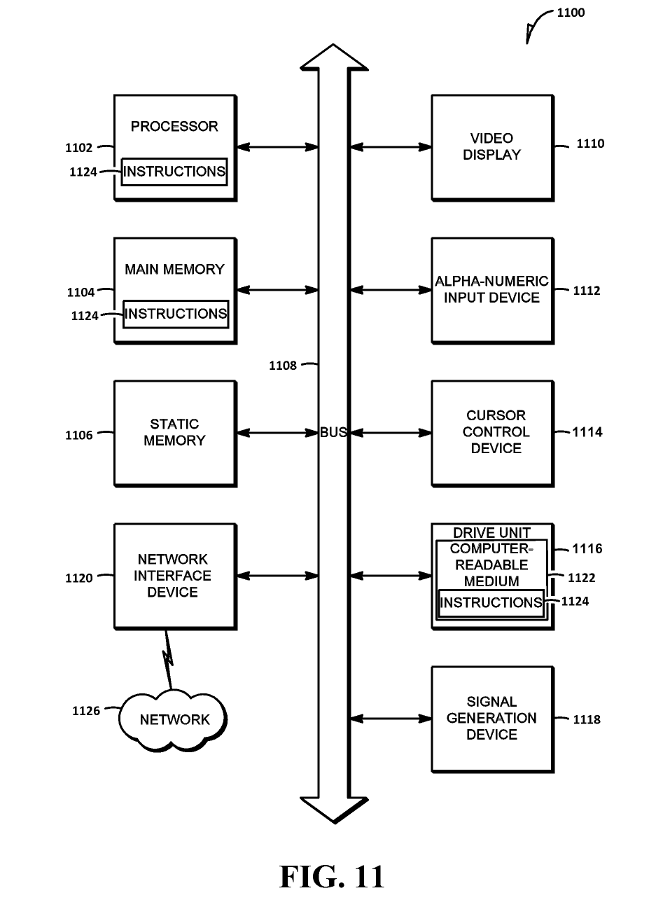

FIG. 11 is a block diagram illustrating components of a machine 1100, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 11 shows a diagrammatic representation of the machine 1100 in the example form of a computer system and within which instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include a collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a light emitting diode (LED) display, a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., instructions 1124) for execution by a machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A gateway comprising:
a memory;
a processor coupled to the memory, the processor comprising a communication module, a remote device management module, and a license plate module,
the communication module configured to communicate with a web server, a client device introduced to the gateway by the web server, and at least one other gateway and to copy a configuration of the gateway to the at least one other gateway;
the remote device management module configured to aggregate monitoring data from a plurality of security devices coupled to the gateway and from at least one other security device respectively coupled to the at least one other gateway, the at least one other gateway correlated with the gateway by the web server, and to enable the client device to monitor the plurality of security devices coupled to the gateway and the at least one other security device coupled to the at least one other gateway; and
the license plate module configured to generate a predictive behavioral model using historical data from the monitoring data comprising identified characters in license plates of vehicles monitored by the at least one other security device.

2. The gateway of claim 1, wherein the license plate module comprises:
a historical data analysis module configured to access the historical data collected with a license plate recognition module configured to identify characters in the license plates in a picture from a non-infrared camera coupled to the gateway;
a prediction module configured to generate the prediction behavioral model using statistical computation on the historical data; and
an alert module configured to compare current data generated from a current picture from the non-infrared camera with the prediction behavioral model, and to generate an alert based on the comparison.

3. The gateway of claim 2, wherein the license plate module is configured to simultaneously processes the license plates and identify the characters in the license plates of a portion of the plurality vehicles using the non-infrared camera coupled to the gateway, and to generate indicators corresponding to the license plates on the picture generated by the non-infrared camera.

4. The gateway of claim 3, wherein the license plate module comprises:
a preset configuration module configured to generate a plurality of preset camera positions of the non-infrared camera to cover a location;
a camera position control module configured to move the camera according to the plurality of preset camera positions; and
a license plate analysis module configured to identify the license plates with each preset camera positions and to compare the characters of each license plate with each preset camera position with a database to correlate the license plates with the plurality of preset camera positions.

5. The gateway of claim 3, wherein the license plate module further comprises:
a vehicle identification module configured to identify a make and model of each vehicle in the picture from the non-infrared camera.

6. The gateway of claim 5, wherein the license plate module further comprises:
a license plate verification module configured to access data corresponding to a license plate of the vehicle based on the license plate recognition module; and
a license plate display module configured to generate a first set of indicators associated with the accessed data corresponding to the license plate and a second set of indicators associated with the make and model of the vehicle, the first and second set of indicators adjacent to a picture of the vehicle in a display.

7. The gateway of claim 2, wherein the license plate recognition module is configured to:
set a detection zone from a target scene in the picture;
read an OCR table from a database file, each character in the OCR table containing numbers indicating their feature sets;
read a new frame;
convert the new frame into gray scale;
break down to small bricks based on an image size of picture;
loop through all bricks in each scale level with local normalization for every brick, removal of isolated bricks, association of connected brick regions, and determination of the maximum and minimum brick region by probabilities;
sort extracted brick regions by density;
loop through all brick regions to determine possible license plates by normalizing brick regions, and filtering unlike plate region by checking minimum and maximum pixel size;
loop through license plates to determine overlap;
segment characters in the license plate;
determine a rotation of the license plate;
determine a fade out direction of the license plate;
calculate a point to pivot and the shear pivot;
re-sample the license plate to counteract till; and
merge existing license plates from historical results.

8. The gateway of claim 1, wherein the processor further comprises:
an application programming interface (API) module configured to interface the gateway with a client device;
an application module configured to monitor and control the plurality of security devices coupled to the gateway;
a device driver configured to enable interaction of the application module with the corresponding security device; and
the communication module further configured to receive additional APIs, respective application modules, and respective device drivers.

9. The gateway of claim 8, wherein the communication module comprises:
a user authentication module configured to authenticate a user at the client device based on a user profile of the user;
a user access policy module configured to limit or grant the user at the client device access to at least one of the plurality of security devices;
a web server authentication module configured to authenticate a communication between the gateway and the web server; and
a transport module configured to enable peer-to-peer communication between gateways, the client device, and the web server.

10. The gateway of claim 8, wherein the remote device management module comprises:
an analytics module configured to analyze audio, video, and data from the plurality of security devices and to generate events based on the analysis;
an event aggregation module configured to aggregate events generated from the analytics module;
an event-based control module configured to communicate a command to at least one of the security device of the corresponding gateway based on an event identified in the aggregated events based on an event configuration; and
a client-based control module configured to communicate a command to the at least one security device of the corresponding gateway based on a command communicated from the client device.

11. The gateway of claim 8, wherein the security device comprises a camera control device, an audio control device, a switch, a HVAC system, a video device, an audio device, a biometric sensor, an access control device, a temperature sensor, an RFID device, or a motion-controlled sensor.

12. The gateway of claim 8, wherein the web server comprises a web-based gateway management application configured to identify a gateway associated with a user at the client device, to authenticate with the user at the client device, to authenticate with the identified gateway, and to correlate the identified gateway with the other gateways.

13. The gateway of claim 12, wherein the web-based gateway management application comprises:
a gateway directory manager configured to identify a gateway associated with a user profile;
a user authentication module configured to authenticate with the user at the client device based on the user profile; and
a gateway authentication module configured to authenticate the identified gateway,
wherein the gateway directory manager comprises a service manager module configured to enable an add-on service to the user at the client device.

14. The gateway of claim 13, wherein the add-on service comprises remote storage, remote audio, two-way audio, dynamic backup, reporting based on the user profile, organization topology mapping, or gateway access configuration.

15. The gateway of claim 8, wherein the client device is configured to communicate with a first gateway identified by the web server, to receive monitoring data from a second security device coupled to a second gateway, to control the second security device coupled to the second gateway by communicating with the first gateway coupled to a first security device, the first gateway correlated with the second gateway by the web server.

16. A method comprising:
identifying at a gateway, a web server, a client device, and at least one other gateway;
aggregating monitoring data from a plurality of security devices coupled to the gateway and from at least one other security device respectively coupled to the at least one other gateway, the at least one other gateway correlated with the gateway by the web server;
enabling the client device to monitor and control the plurality of security devices coupled to the gateway and the at least one other security device coupled to the at least one other gateway; and
generating a predictive behavioral model using historical data from the monitoring data comprising identified characters in license plates of vehicles monitored by the at least one other security device.

17. The method of claim 16, further comprising:
detecting and identifying characters in the license plates depicted in a picture from a non-infrared camera coupled to the gateway;
accessing the historical data collected with the identifying;
generating the prediction behavioral model using statistical computation on the historical data;
comparing current data generated from a current picture from the non-infrared camera with the prediction behavioral model; and
generating an alert based on the comparing.

18. The method of claim 16, further comprising:
simultaneously identifying the characters in the license plates of a portion of the plurality vehicles using a non-infrared camera coupled to the gateway; and
generating indicators corresponding to the license plates on a picture generated by the non-infrared camera.

19. The method of claim 16, further comprising:
setting a detection zone from a target scene in the picture;
reading an OCR table from a database file, each character in the OCR table containing numbers indicating their feature sets;
reading a new frame;
converting the new frame into gray scale;
breaking down to small bricks based on an image size of picture;
looping through all bricks in each scale level with local normalization for every brick, removal of isolated bricks, association of connected brick regions, and determination of the maximum and minimum brick region by probabilities;
sorting extracted brick regions by density;
looping through all brick regions to determine possible license plates by normalizing brick regions, and filtering unlike plate region by checking minimum and maximum pixel size;
looping through license plates to determine overlap;
segmenting characters in the license plate;
determining a rotation of the license plate;
determining a fade out direction of the license plate;
calculating a point to pivot and the shear pivot;
re-sampling the license plate to counteract till; and
merging existing license plates from historical results.

20. A non-transitory computer-readable storage medium storing a set of instructions that, when executed by a processor, cause the processor to perform operations, comprising:
identifying at a gateway, a web server, a client device, and at least one other gateway;
aggregating monitoring data from a plurality of security devices coupled to the gateway and from at least one other security device respectively coupled to the at least one other gateway, the at least one other gateway correlated with the gateway by the web server;
enabling the client device to monitor and control the plurality of security devices coupled to the gateway and the at least one other security device coupled to the at least one other gateway; and
generating a predictive behavioral model using historical data from the monitoring data comprising identified characters in license plates of vehicles monitored by the at least one security device.
